(19) United States
(12) Patent Application Publication
(10) Pub. No.: US 2009/0323333 A1
(43) Pub. Date: Dec. 31, 2009

(54) LED LAMP

(75) Inventor: CHIA-SHOU CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/430,845

(22) Filed: Apr. 27, 2009

(30) Foreign Application Priority Data
Jun. 25, 2008 (CN) 200810068107.4

(51) Int. Cl. F21V 11/00; F21V 7/00

(52) U.S. Cl. 362/240; 362/309

(57) ABSTRACT

An LED lamp includes a lamp holder, a lens, and at least one LED. The lamp holder includes a substrate and a reflector expanding from an outer periphery of the substrate. The lens couples to the reflector of the lamp holder to seal a receiving space of the lamp holder. The at least one LED is received in the receiving space and arranged on the substrate. The lens includes an incident surface facing the receiving space and an opposite emitting surface. At least one micro-structure is formed on the incident surface of the lens corresponding to the at least one LED. The at least one micro-structure is located on a central axis of the at least one LED, for diffusing the light generated by the at least one LED.

### BACKGROUND

1. Technical Field

The disclosure generally relates to LED lamps, and particularly to an LED lamp with a uniform light distribution.

2. Description of Related Art

In recent years, LEDs are preferred for use in illumination devices rather than CCFLs (cold cathode fluorescent lamps) due to their excellent properties, including high brightness, long lifespan, wide color range, and etc. However, the LED is a point light source, and an emitting surface thereof is usually hemispherical. Intensity of a light field of the LED decreases gradually and outwardly along a radial direction thereof. The intensity of the light field of the LED is uneven, being strong at a center of the light field of the LED and weak at the periphery of the light field of the LED.

For the foregoing reasons, therefore, there is a need in the art for an LED lamp which overcomes the limitations described.

### BRIEF DESCRIPTION OF THE DRAWINGS

FIG. 1 is an isometric, assembled view of an LED lamp according to an exemplary embodiment.

FIG. 2 is an exploded view of the LED lamp of FIG. 1.

FIG. 3 is a cross-sectional view of the LED lamp of FIG. 1, taken along line III-III thereof.

FIG. 4 is a top plan view of the LED lamp of FIG. 1.

FIG. 5 is a cross-sectional view of an LED lamp according to an alternative embodiment.

### DETAILED DESCRIPTION

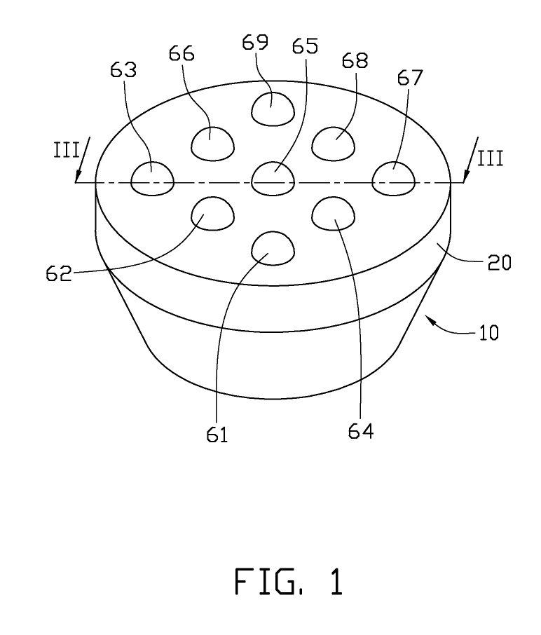

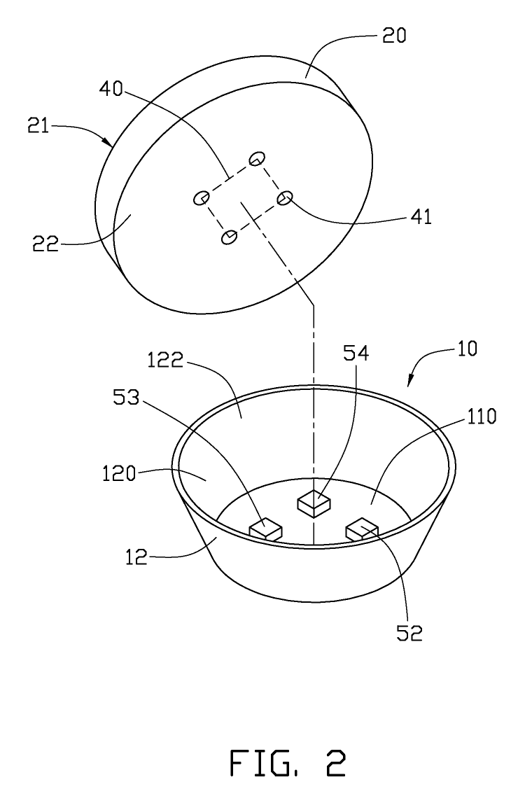

Referring to FIGS. 1 and 2, an LED lamp according to an exemplary embodiment includes a lamp holder 10, a lens 20, and a plurality of LEDs 51, 52, 53, 54. In this embodiment, there are four LEDs, which include a first LED 51, a second LED 52, a third LED 53, and a fourth LED 54.

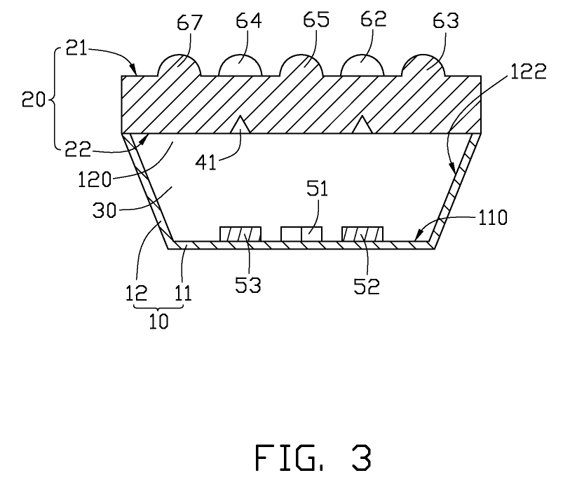

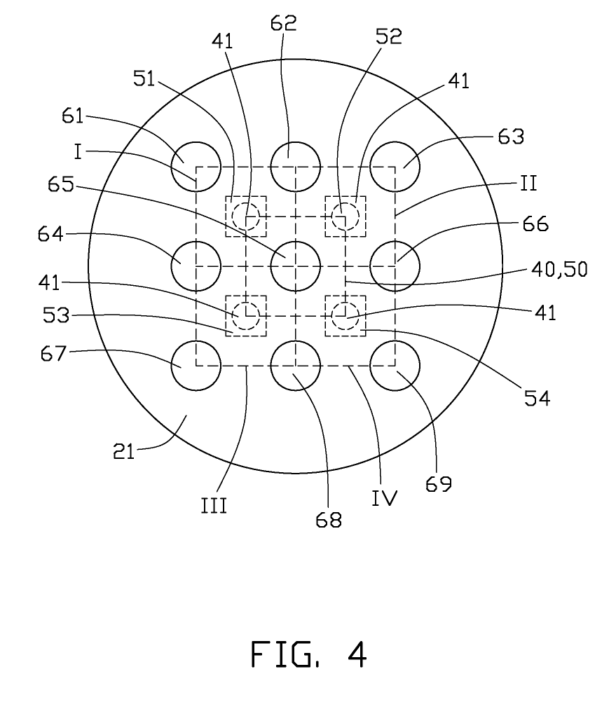

Referring to FIGS. 3 and 4, the lamp holder 10 includes a substrate 11 and a reflector 12. The substrate 11 is a circular plate, and has a flat top surface 110 for mounting the LEDs 51, 52, 53, 54 thereon. The four LEDs 51, 52, 53, 54 are respectively positioned at four corners of a square 50 surrounding a central axis of the substrate 11, in which a center of the square 50 is coincident with the central axis of the substrate 11.

The reflector 12 is conversely truncated conical, which expands upwardly from an outer periphery of the substrate 11 with a top side 120 thereof being open. An inner surface 122 of the reflector 12 has a diameter increasing gradually from the substrate 11 along a bottom-to-top direction. A layer of material with a high reflectivity, such as mercury, aluminum, silver, aurum or copper, which can reflect the light of the LEDs 51, 52, 53, 54 towards the open top side 120 of the reflector 12 is coated on the inner surface 122 of the reflector 12.

In this embodiment, the lens 20 is a disk-shaped plate, and has a diameter the same as an outer diameter of the reflector 12 at the open top side 120. The lens 20 couples to and seals the open top side 120 of the reflector 12 of the lamp holder 10. A central axis of the lens 20 is collinear with the central axis of the substrate 11. A receiving space 30 is defined in the lamp holder 10, which has an open top end sealed by the lens 20. The receiving space 30 is provided for accommodating the LEDs 51, 52, 53, 54 therein. The receiving space 30 is surrounded by the reflector 12 and located above the substrate 11. Each of the LEDs 51, 52, 53, 54 has an emitting side facing the lens 20. The inner surface 122 of the reflector 12 is immediately adjacent to the receiving space 30. Similarly, the receiving space 30 is conversely truncated conical and has a diameter increasing gradually and upwardly along the central axis of the substrate 11.

The lens 20 includes an incident surface 22 facing the receiving space 30 and an opposite emitting surface 21 facing an exterior of the LED lamp. A plurality of micro-structures are integrally formed on the incident surface 22 of the lens 20. In this embodiment, the micro-structures are four cavities 41 concaved inwardly (i.e., upwardly) from the incident surface 22 of the lens 20. Each cavity 41 has a shape of a cone or a pyramid. The four cavities 41 are formed corresponding to four LEDs 51, 52, 53, 54, respectively, regarding the location thereof. Accordingly, the fore cavities 41 cooperatively define a square 40 having a size the same as the square 50 defined by the LEDs 51, 52, 53, 54. Each cavity 41 is located over one corresponding LED 51, 52, 53, 54. In other words, each cavity 41 and the corresponding LED 51, 52, 53, 54 define a vertical line parallel to the central axis of the substrate 11.

Referring to FIG. 1 and FIG. 4, there are nine nubs, which include a first nub 61, a second nub 62, a third nub 63, a fourth nub 64, a fifth nub 65, a sixth nub 66, a seventh nub 67, an eighth nub 68, and a ninth nub 69, integrally formed on the emitting surface 21 of the lens 20. Each of the nubs 61, 62, 63, 64, 65, 66, 67, 68, 69 has an outer (i.e. top) surface being spherical. The nine nubs 61, 62, 63, 64, 65, 66, 67, 68, 69 are arranged in three lines by there lines. In other words, the nine nubs 61-69 are arranged in a 3×3 array. The fifth nub 65 is located on the central axis of the lens 20, and the other eight nubs 61, 62, 63, 64, 66, 67, 68, 69 surround the fifth nub 65. Four neighboring nubs define a square, i.e., the first, second, fourth and fifth nubs 61, 62, 64, 65 defines a first square I, the second, third, fifth and sixth nubs 62, 63, 65, 66, defines a second square II, the fourth, fifth, seventh and eighth nubs 64, 65, 67, 68 defines a third square III, and the fifth, sixth, eighth and ninth nubs 65, 66, 68, 69 defines a fourth square IV The first LED 51 is located at a center of the first square I, the second LED 52 is located at a center of the second square II, the third LED 53 is located at a center of the third square III, and the fourth LED 54 is located at a center of the fourth square IV, as viewed from a top of the LED lamp (best seen in FIG. 4).

When the LEDs 51, 52, 53, 54 emit light, a part of the light travels to the incident surface 22 of the lens 20 directly, and another part of the light travels to the inner surface 122 of the reflector 12 of the lamp holder 10 and is redirected to the incident surface 22 of the lens 20 by the inner surface 122 of the reflector 12. When the light reaches the incident surface 22 of lens 20 at a position forming the cavities 41, the cavities 41 diffuse the light thereat. Since the cavities 41 are located over centers of the LEDs 51, 52, 53, 54, respectively, each cavity 41 is located at a center of a light field of the light generated by a corresponding one of the LEDs 51, 52, 53, 54, whereby an intensity at the center of the light field is decreased by the diffusing action of the corresponding cavity 41, and the intensity at a periphery of the light field is enhanced by the diffused central portion of the light. Therefore, the light enter into the lens 20 is more evenly. Furthermore, as the nubs 61, 62, 63, 64, 65, 66, 67, 68, 69 are formed on the emitting surface 21 of the lens 20 surrounding the LEDs 51, 52, 53, 54, the light of the LEDs 51, 52, 53, 54 is converted to be generally parallel light after moving across the lens 20, such that each LED 51, 52, 53, 54 can function as a surface light source. Intensity of the light field of the LED lamp is thus more uniform.

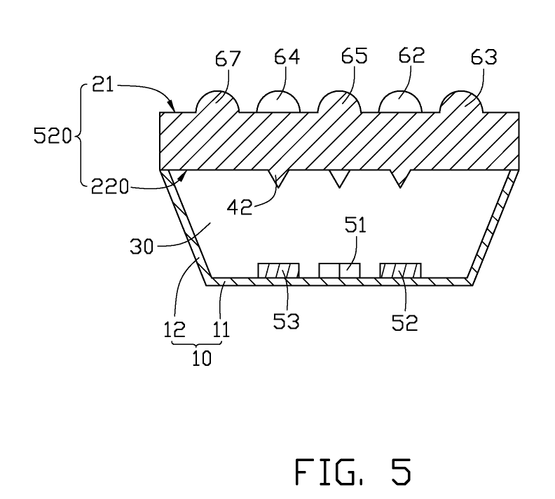

FIG. 5 shows an LED lamp according to an alternative embodiment, which is different from the previous embodiment only in that: the micro-structures are formed on the incident surface 220 of the lens 520 are four protrusions 42, which extend outwardly (i.e., downwardly) into the receiving space 30 from the incident surface 220 of the lens 520. Each protrusion 42 is located over one corresponding LED 51, 52, 53, 54, and has a shape of a cone or a pyramid. Similar to the cavities 41, each of the protrusions 42 can diffuse the light at the center of the light filed of the corresponding LED 51, 52, 53, 54, and thus to enhance the intensity of the light at the periphery of the light field.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An LED lamp, comprising:
a lamp holder comprising a substrate and a reflector expanding upwardly from an outer periphery of the substrate, a receiving space being defined in the lamp holder, the receiving space being surrounded by the reflector and located above the substrate;
a lens coupling to a top of the reflector and sealing the receiving space of the lamp holder; and
a plurality of LEDs received in the receiving space an arranged on the substrate, the lens defining a plurality of micro-structures corresponding to the plurality of LEDs, respectively, in number and position.

2. The LED lamp of claim 1, wherein the micro-structures are formed on an incident surface of the lens facing the receiving space, and each micro-structure is located over a center of a corresponding LED.

3. The LED lamp of claim 2, wherein the micro-structures are cavities concaved upwardly from the incident surface of the lens.

4. The LED lamp of claim 2, wherein the micro-structures are protrusions extending downwardly from the incident surface of the lens into the receiving space.

5. The LED lamp of claim 1, wherein the micro-structures are integrally formed with the lens.

6. The LED lamp of claim 1, wherein each micro-structure has a shape of one of a cone and a pyramid.

7. The LED lamp of claim 1, wherein a plurality of nubs are integrally formed on an emitting surface of the lens facing upwardly toward an exterior of the LED lamp.

8. The LED lamp of claim 7, wherein the plurality of LEDs are evenly arranged around a center of the substrate, each LED is surround by some of the nubs as viewed from a top of the LED lamp.

9. The LED lamp of claim 8, wherein the plurality of LEDs are four in number, and the plurality of nubs are nine in number, the nine nubs being arranged in a 3×3 array, each LED being surround by four neighboring nubs and located at a center of the four surrounding nubs, as viewed from the top of the LED lamp.

10. An LED lamp, comprising:
at least one LED for generating light; and
a lens having an incident surface for the light of the at least one LED traveling into the lens and an opposite emitting surface for the light traveling through the lens to emit to an exterior, at least one micro-structure being formed on the incident surface of the lens corresponding to the at least one LED, the at least one micro-structure being located on a central axis of the at least one LED for diffusing the light generated by the at least one LED.

11. The LED lamp of claim 10, wherein the at least one micro-structure is a cavity concaved inwardly from the incident surface of the lens.

12. The LED lamp of claim 10, wherein the at least one micro-structure is a protrusion extending outwardly from the incident surface of the lens towards the at least one LED.

13. The LED lamp of claim 10, wherein a plurality of nubs are integrally formed on the emitting surface of the lens.

14. The LED lamp of claim 13, wherein the at least one LED is four in number, and the plurality of nubs are nine in number, the nine nubs being arranged in a 3×3 array, each LED being surround by four neighboring nubs and located at a center of the four surrounding nubs, as viewed from a top of the LED lamp.

15. The LED lamp of claim 10, wherein each of the at least one micro-structure has a shape of one of a cone and a pyramid.
